(19) United States
(12) Patent Application Publication
(10) Pub. No.: US 2005/0247223 A1
(43) Pub. Date: Nov. 10, 2005

(54) Printing plate material, printing plate and printing process

(75) Inventor: Takeshi Sampei, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA MEDICAL & GRAPHIC, INC.

(21) Appl. No.: 11/119,811

(22) Filed: May 3, 2005

(30) Foreign Application Priority Data
May 6, 2004 (JP) JP2004-137137

(51) Int. Cl. B41N 1/14

(52) U.S. Cl. 101/460

(57) ABSTRACT

Disclosed are a printing plate employing its printing material comprising a polyester support with no coating imperfection, excellent dot image quality, rich ink receptivity at the beginning of printing and excellent ink stain elimination property in non-image portions, and the printing process thereof. Specifically provided is the printing plate material having a polyester support and provided thereon, an image formation layer, at least one adhesion layer being provided between the support and the image formation layer, wherein the adhesion layer contains (A) a copolyester, (B) a water-soluble polymer selected from the group consisting of polyvinyl alcohol and polyvinyl pyrrolidone, and (C) particles.

This application claims priority from Japanese Patent Application No. Jp2004-137137 filed on May 6, 2004, which is incorporated hereinto by reference.

### TECHNICAL FIELD

The present invention relates to a printing plate material and a printing plate having a polyester support, and a printing process employing the same.

### BACKGROUND

An inexpensive printing plate material for CTP (Computer to Plate) systems, which can be easily handled and has a printing capability comparable to that of PS plates, is required for digitization of printing data. Laser recording at various wavelengths is usually used for the CTP image formation process.

A metal plate, such as aluminum, is commonly employed as a support of a printing plate material used for CTP. Recently, however, a printing plate material employing as a support a plastic film sheet has been developed, which is easier to handle and carry. (Refer to Patent Documents 1, 2, 3 and 4, for example.)

However, when a CTP printing plate material using these plastic supports is used, unevenness in printing caused by streaks on the coated surface tends to appear. It is seen as a problem that a defect develops, in the case of printing with a so-called coating imperfection, resulting in lowering of dot image quality. Further, a suitable printing property, an ink receptivity property at the beginning of printing and poorness of eliminating ink stain in non-image portions during printing under conventional conditions, so-called ink stain elimination property are insufficient, and a printing plate material in which the foregoing problems are minimized has strongly been desired.

(Patent Document 1) Japanese Patent O.P.I. Publication No. 4-261539

(Patent Document 2) Japanese Patent O.P.I. Publication No. 5-257287

(Patent Document 3) Japanese Patent O.P.I. Publication No. 2000-258899

(Patent Document 4) Japanese Patent O.P.I. Publication No. 2002-79772

### DISCLOSURE OF THE INVENTION

### PROBLEMS TO BE SOLVED BY THE PRESENT INVENTION

### SUMMARY

An object of the invention is to provide a printing plate and its printing material comprising a polyester support with zero coating imperfections, excellent dot image quality, rich ink receptivity even at the beginning of printing and excellent ink stain elimination property in non-image portions, and the printing process thereof.

### DESCRIPTION OF THE PREFERRED EMBODIMENTS

The above object has been attained by one of the following structures.

(Structure 1) A printing plate material having a polyester support and provided thereon, an image formation layer, at least one adhesion layer being provided between the support and the image formation layer, wherein the adhesion layer contains (A) a copolyester, (B) a water-soluble polymer selected from the group consisting of polyvinyl alcohol and polyvinyl pyrrolidone, and (C) particles.

(Structure 2) The printing plate material of Structure 1, wherein the copolyester comprises in the molecule a hydroxyl group-containing component and a carboxylic acid component including a dicarboxylic acid component with a sulfonate group, and wherein the content of the dicarboxylic acid component in the copolyester is from 1 to 16 mol % based on the carboxylic acid component.

(Structure 3) The printing plate material of Structure 1, wherein a saponification degree of polyvinyl alcohol is from 75 to 95 mol %, or a K value of polyvinyl pyrrolidone is from 26 to 100.

(Structure 4) The-printing plate material of Structure I, wherein the particles are organic or inorganic, and have an average particle size of from 20 to 80 nm.

(Structure 5) The printing plate material of Structure 1, wherein the copolyester content is from 30 to 80% by weight, the water-soluble polymer content is from 5 to 50% by weight, and the particle content is from 1 to 30% by weight, based on the weight of the adhesion layer.

(Structure 6) The printing plate material of Structure 1, wherein a thickness of the polyester support is from 100 to 300 μm.

(Structure 7) The printing plate material of Structure 1 or 6, wherein the image formation layer contains heat melting particles and heat fusible particles.

(Structure 8) The printing plate material of any one of Structures 1, 6, and 7, wherein at least one hydrophilic layer is provided between the adhesion layer and the image formation layer.

(Structure 9) The printing plate material of Structure 8, wherein the at least one hydrophilic layer has a porous structure.

(Structure 10) The printing plate material of any one of Structures 1, 6, 7., 8, and 9, wherein the printing plate material has a layer containing a light-heat conversion material.

(Structure 11) The printing plate material of Structure 10, wherein the image formation layer or the hydrophilic layer contains the light-heat conversion material.

(Structure 12) The printing plate material of Structure 1, wherein a hydrophilic overcoat layer is provided on the image formation layer.

(Structure 13) The printing plate material of Structure 12, wherein the hydrophilic overcoat layer contains the light-heat conversion material.

(Structure 14) The printing plate material of Structures 1, 6, 7, 8, 9, and 10, wherein the printing plate material is wound around a core having a diameter of 4 to 10 cm so as to form a printing plate material roll.

(Structure 15) A printing plate which is obtained by unwinding the printing plate material from the printing plate material roll of Structure 14, and imagewise exposing the image formation layer of the unwound printing plate material, employing laser beams.

(Structure 16) A printing process having the steps of producing through-holes in the printing plate of Structure 15, and fixing the resulting printing plate on a plate cylinder of a printing press, employing the through-holes.

### DETAILED DESCRIPTION OF THE INVENTION

The present invention will be detailed below.

(Adhesion Layer)

In the present invention, at least one adhesion layer is provided between the support and the image formation layer, and the adhesion layer contains (A) a copolyester, (B) a water-soluble polymer selected from the group consisting of polyvinyl alcohol and polyvinyl pyrrolidone, and (C) particles.

It is preferable that: (A) copolyester used as a component for forming this adhesion layer is a polymer in which the content of a dicarboxylic acid component with a sulfonate group is from 1 to 16 mol %, based on the total carboxylic acid component in the molecule. The copolyester used as an aqueous solution, aqueous dispersion or emulsion is a polyester composed of a carboxylic acid component such as terephthalic acid, isophthalic acid, 2,6-naphthalene dicarboxylic acid, hexahydro terephthalic acid, 4,4′-diphenyl dicarboxylic acid, phenylindan dicarboxylic acid, adipic acid, sebacic acid, 5-sulfo isophthalic acid, trimellitic acid or dimethylol propionic acid, a dicarboxylic acid component with a sulfonate group such as 5-Na sulfo isophthalic acid, 5-K sulfo isophthalic acid or 5-K sulfo terephthalic acid, and a hydroxyl group-containing component such as ethylene glycol, diethylene glycol, neopentylene glycol, 1,4-butanediol, 1,6-hexanediol, 1,4-cyclohexanedimethanol, glycerin, trimethylolpropane or bisphenol A with an alkylene oxide additive.

In order to add hydrophilicity, the copolyester is a polymer in which the content of a dicarboxylic acid component with a sulfonate group is preferably from 1 to 16 mol %, and is more preferably from 1.5 to 14 mol %, based on the total carboxylic acid component in the molecule. In the case of the content of a dicarboxylic acid component with a sulfonate group being from 1 to 16 mol %, it is preferable that hydrophilicity of the copolyester is sufficient, and moisture resistance of the coated layer is also improved. It is also preferable that the second transition point (Tg) of the copolyester is from 20 to 90° C., and it is further preferable that the anti-scraping and adhesion properties of film are improved by occurrence of anti-blocking of the film, in the case of Tg being from 20 to 90° C.

(B) water-soluble polymer selected from the group consisting of polyvinyl alcohol and polyvinyl pyrrolidone, which is used as a component for forming the above adhesion layer, will now be explained. It is preferable that the polyvinyl alcohol has a saponification degree of from 75 to 95 mol %. In the case of this saponification degree being from 75 to 95 mol %, it is preferable that moisture resistance of the coated layer and adhesion to the ink image receiving layer are improved. Further, a cation-modified polyvinyl alcohol is preferably used, since it adheres well to the ink image receiving layer. It is also preferable that polyvinyl pyrrolidone has a K value of from 26 to 100. In the case of the K value being from 26 to 100, it is preferable that the strength of the coated layer and adhesion to the ink image receiving layer are improved.

(C) particles used as a component for forming the above adhesion layer are organic or inorganic, and have an average particle size of from 20 to 80 nm, and preferably of from 25 to 65 nm. Examples of the particles include calcium carbonate, calcium oxide, aluminium oxide, kaolin, silicon oxide, zinc oxide, cross-linked acryl resin particles, cross-linked polystyrene resin particles, melamine resin particles and cross-linked silicone particles. It is also preferable that the anti-scraping property of film is improved by occurrence of anti-blocking of the film, in the case of the average particle size being from 20 to 80 nm.

Further, it is preferable in the present invention that (A) the copolyester content is from 30 to 80% by weight, (B) the content of a water-soluble polymer selected from the group consisting of polyvinyl alcohol and polyvinyl pyrrolidone is from 5 to 50% by weight, and (C) the particle content is from 1 to 30% by weight, based on the weight of the adhesion layer.

Other components except those in (A), (B) and (C) used for the adhesion layer in the present invention may optionally be contained. Examples usable for these components include other resins, an anti-static agent, a colorant, a surfactant, a UV absorber and a cross-linking agent. Examples of a preferable cross-linking agent include an oxazoline group-containing polymer, a urea-containing resin, a melamine-containing resin and an epoxy resin. Compounds expressed by Formula (1) disclosed in Japanese Patent O.P.I. Publication No. 2000-336309 and described in Japanese Patent O.P.I. Publication No. 2000-168012, items [0016]-[0029] can be preferably used.

It is further preferable that the anti-scraping, anti-blocking and transporting properties of the adhesion layer are enhanced, in the case of the center line average surface roughness (Ra) of the adhesion layer surface of a polyester film sheet having an adhesion layer in the present invention being from 10 to 250 nm, and preferably 10 to 100 nm. A coated layer with such an Ra, for example, can be obtained by employing the foregoing content of the particles as a coating liquid component for an adhesion layer.

Incidentally, in the present invention, an adhesion layer comprised of the foregoing components is to be formed on at least one surface of the polyester film sheet support. The adhesion layer, for example, can be formed on a stretchable polyester film sheet by conducting the processes of drying, stretching and optional heat-treating after a water-based liquid containing the components to form the adhesion layer is coated. A solid concentration of this water-based liquid is usually not more than 30% by weight, and is more preferably not more than 10% by weight.

The above stretchable polyester film sheet is any one of an unstretched polyester film sheet, a uniaxially stretched polyester film sheet or a biaxially stretched polyester film sheet. Among these, especially preferable is a longitudinally stretched polyester film sheet which is uniaxially stretched in the extruding direction of the film sheet (in the longitudinal direction).

In the case of coating a water-based liquid onto the polyester film sheet, since dust and foreign matter are easily inhaled, it is not recommended that a regular coating process, which is in relation to the biaxially stretched and heat fixed polyester film sheet, is separately conducted from the process for manufacturing the film sheet. The coating process, that is to say, a coating process in a manufacturing process of the film sheet, is preferably conducted under a clean atmosphere, and adhesiveness onto the polyester film of this adhesion layer increases based on this coating process.

Known coating methods may be employed as appropriate. A roll coating method, a gravure coating method, a roll brushing method, a spray coating method, an air knife coating method, an impregnation method or a curtain coating method, as examples, can be used singly or in combination. The amount of the coated film which is transported is preferably from 0.5 to 20 g/m², and is more preferably 1 to 10 g/m². It is also preferable that the water-based liquid used is an aqueous dispersion or emulsion.

The stretchable polyester film sheet coated with a water-based liquid is introduced into a drying process and a stretching treatment process. This process may be conducted under the conditions which have been stored in the past by this industry. For example, the drying condition is preferably 90-130° C. for 2-10 minutes, and the stretching temperature is from 90 to 130° C. The stretching ratio is 3-5 times in the longitudinal direction and also 3-5 times in the transverse direction. The re-stretching ratio is optionally 1-3 times, and the heat fixing conditions are 180-240° C. for 2-20 minutes.

It is preferable that the polyester film sheet after conducting those processes, has a thickness of from 100 to 300 μm, and that of the adhesion layer is from 0.02 to 1 μm.

The polyester used in the polyester film is not specifically limited, and contains, as a main component, a dicarboxylic acid unit and a diol unit. There are, for example, polyethylene terephthalate (hereinafter also referred to as PET), and polyethylene naphthalate (hereinafter also referred to as PEN). The polyester is preferably PET, a copolyester comprising a PET component as a main component in an amount of not less than 50% by weight, or a polymer blend comprising PET in an amount of not less than 50% by weight.

PET is a polycondensate of terephthalic acid and ethylene glycol, and PEN is a polycondensate of naphthalene dicarboxylic acid and ethylene glycol. The polyester may be a polycondensate of the dicarboxylic acid and diol, constituting PET or PEN, and one or more kinds of a third component. As the third component, there is a compound capable of forming an eater.

As a dicarboxylic acid, there is, for example, terephthalic acid, isophthalic acid, phthalic acid, 2,6-naphthalene dicarboxylic acid, 2,7-naphthalene dicarboxylic acid, diphenylsulfone dicarboxylic acid, diphenylether dicarboxylic acid, diphenylthioether dicarboxylic acid, diphenylketone dicarboxylic acid, or diphenylindane dicarboxylic acid, and as a diol, there is, for example, propylene glycol, tetramethylene glycol, cyclohexanedimethanol, 2,2-bis(4-hydroxyphenyl)propane, 2,2-bis(4-hydroxyethoxyphenyl)propane, bis(4-hydroxyphenyl)-sulfone, bisphenolfluorene dihydroxyethyl ether, diethylene glycol, neopentylene glycol, hydroquinone, or cyclohexane diol. The third component may be a polycarboxylic acid or a polyol, but the content of the polycarboxylic acid or polyol is preferably from 0.001 to 5% by weight based on the weight of polyester.

The intrinsic viscosity of the polyester in the invention is preferably from 0.5 to 0.8. Polyesters having different viscosity may be used as a mixture of two or more kinds thereof.

A manufacturing method of the polyester is not specifically limited, and the polyester can be manufactured according to a conventional polycondensation method. As the manufacturing method, there is a direct esterification method in which a dicarboxylic acid is directly reacted with a diol by heat application to be esterified while distilling off the extra diol at elevated temperature under reduced pressure, or an ester exchange method.

As catalysts, an ester exchange catalyst ordinarily used in synthesis of polyesters, a polymerization catalyst or a heat-resistant stabilizer can be used. Examples of the ester exchange catalyst include. Ca(OAc) 2.H₂O, Zn(OAc) 22H₂O, Mn(OAc)₂.4H₂O, and Mg(OAc)₂.4H₂O. Examples of the polymerization catalyst include Sb₂O₃ and GeO₂. Examples of the heat-resistant stabilizer include Phosphoric acid, phosphorous acid, PO(OH) (CH₃)₃, PO(OH) (OC₆H₅)₃, and P(OC₆H₅)₃. During synthesis of polyesters, an anti-stain agent, a crystal nucleus agent, a slipping agent, an anti-blocking agent, a UV absorber, a viscosity adjusting agent, a transparentizing agent, an anti-static agent, a pH adjusting agent, a dye or pigment may be added.

(Heat Treatment of Support)

In the invention, the polyester film sheet after stretched and heat-fixed is preferably subjected to heat treatment in order to stabilize dimension of a printing plate and minimize “out of color registration” during printing. After the sheet has been stretched, heat fixed, cooled, wound around a spool once, and unwound, the sheet is properly heat treated at a separate process as follows. As the heat treatment methods in the invention, there are a transporting method in which the film sheet is transported while holding the both ends of the sheet with a pin or a clip, a transporting method in which the film sheet is roller transported employing plural transporting rollers, an air transporting method in which the sheet is transported while lifting the sheet by blowing air to the sheet (heated air is blown to one or both sides of the sheet from plural nozzles), a heating method which the sheet is heated by radiation heat from for example, an infrared heater, a heating method in which the sheet is brought into contact with plural heated rollers to heat the sheet, a transporting method in which the sheet hanging down by its own weight is wound around an up-take roller, and a combination thereof.

Tension at heat treatment can be adjusted by controlling torque of an up-take roll and/or a feed-out roll and/or by controlling load applied to the dancer roller provided in the process. When the tension is changed during or after the heat treatment, an intended tension can be obtained by controlling load applied to the dancer roller provided in the step before, during and/or after the heat treatment. When the transporting tension is changed while vibrating the sheet, it is useful to reduce the distance the heated rollers.

In order to reduce dimensional change on heat processing (thermal development), which is carried out later, without inhibiting thermal contraction, it is desirable to lower the transporting tension as much as possible, and lengthen the heat treatment time. The heat treatment temperature is preferably in the range of from Tg+50° C. to Tg+150° C. In this temperature range, the transporting tension is preferably from 5 Pa to 1 MPa, more preferably from 5 Pa to 500 kPa, and most preferably from 5 Pa to 200 kPa, and the heat treatment time is preferably from 30 seconds to 30 minutes, and more preferably from 30 seconds to 15 minutes. The above described temperature range, transporting tension range and heat treatment time range can prevent the support planarity from lowering due to partial thermal contraction difference of the support occurring during heat treatment and prevent scrapes from occurring on the support due to friction between the support and transporting rollers.

It is preferred that the heat treatment is carried out at least once, in order to obtain an intended dimensional variation rate. The heat treatment can be optionally carried out two or more times. The heat-treated polyester film sheet is cooled from a temperature of around Tg to room temperature and wound around a spool. During cooling to room temperature from a temperature exceeding Tg, the heat-treated polyester film sheet is preferably cooled at a rate of −5° C./second or more in order to prevent lowering of flatness of the sheet due to cooling. The heat treatment may be conducted after the adhesion layer in the present invention and/or the subbing layer described later are/is formed.

(Water Content of Support)

In the invention, in order to secure good transportability of the support in an exposure device or in a developing machine, the water content of the support is preferably not more than 0.5 by weight. The water content of the support in the invention is D′ represented by the following formula.
D′(weight %)=(w′/W′)×100
wherein W′ represents the weight of the support in the equilibrium state at 25° C. and 60% RH, and w′ represents the weight of water contained in the support in the equilibrium state at 25° C. and 60% RH.

The water content of the support is preferably not more than 0.5% by weight, more preferably from 0.01 to 0.5% by weight, and most preferably from 0.01 to 0.3% by weight. As a method of obtaining a support having a water content of not more than 0.5% by weight, there is (1) a method in which the support is heat treated at not less than 100° C. immediately before a hydrophilic layer or another layer is coated on the support, (2) a method in which a hydrophilic layer or another layer is coated on the support under well-controlled relative humidity, and (3) a method in which the support is heat treated at not less than 100° C. immediately before a hydrophilic layer or another layer is coated on the support, covered with a moisture shielding sheet, and then uncovered. Two or more of these methods may be used in combination.

(Subbing Layer Coating on the Support)

In order to increase adhesion between the polyester support and a coating layer, the surface of the support may be subjected to adhesion treatment or be coated with a subbing layer. Examples of the adhesion treatment include corona discharge treatment, flame treatment, plasma treatment and UV light irradiation treatment.

The subbing layer is preferably, more preferably a layer containing gelatin or latex. A conductive layer containing a conductive polymer disclosed in Japanese Patent O.P.I. Publication No. 7-20596, items [0031]-[0073] or a conductive layer containing a metal oxide disclosed in Japanese Patent O.P.I. Publication No. 7-20596, items [0074]-[0081] is preferably provided on the support. The conductive layer may be provided on one side or on both sides of the polyester film sheet support. It is preferred that the conductive layer be provided on the image formation layer side of the support. The conductive layer restrains electrostatic charging, reduces dust deposition on the support, and greatly reduces white spot faults at image portions during printing.

The polyester support in the invention is preferably a polyester film sheet, but may be a composite support in which a plate of a metal (for example, iron, stainless steel or aluminum) or a polyethylene-laminated paper sheet is laminated onto a polyester film sheet. The composite support may be one in which the lamination is carried out before any layer is coated on the support, one in which the lamination is carried out after any layer has been coated on the support, or one in which the lamination is carried out immediately before mounted on a printing press.

(Particles)

Particles having a size of from 0.01 to 10 μm are preferably incorporated in an amount of from 1 to 1,000 ppm into the support, in improving handling property.

Herein, the particles may be organic or inorganic material. Examples of the inorganic material include silica described in Swiss Patent 330158, glass powder described in French Patent 296995, and carbonate salts of alkaline earth metals, cadmium or zinc described in British Patent 1173181. Examples of the organic material include starch described in U.S. Pat. No. 2,322,037, starch derivatives described such as in Belgian Patent 625451 and British Patent 981198, polyvinyl alcohol described in JP-B 44-3643, polystyrene or polymethacrylate described in Swiss Patent 330158, polyacrylonitrile described in U.S. Pat. No. 3,079,257 and polycarbonate described in U.S. Pat. No. 3,022,169. The shape of the particles may be in a regular form or irregular form.

The light sensitive printing plate material of the invention comprises a polyester support, and provided thereon, an image formation layer, wherein an image capable of being printed is formed on the image formation layer after imagewise exposed or after imagewise exposed and developed. The light sensitive printing plate material of the invention is preferably a printing plate material forming an image according to an ablation type printing plate material forming an image employing a thermal laser or a thermal head, or a silver salt diffusion transfer method disclosed in JP-8-507727 or Japanese Patent O.P.I. Publication No. 6-186750, a heat melt image layer on-press development type printing plate material or a heat fusible transfer type printing plate material disclosed in Japanese Patent O.P.I. Publication No. 9-123387. Among these, an ablation type printing plate material, a heat melt image layer on-press development type printing plate material, a heat fusible transfer type printing plate material, or a phase change type printing plate material, each being a processless CTP printing plate material, is preferred since load to environment is reduced.

(Image Formation Layer)

The image formation layer in the invention preferably contains heat melting particles and/or heat fusible particles.

(Heat Melting Particles)

The heat melting particles used in the invention are particularly particles having a low melt viscosity, or particles formed from materials generally classified into wax. The materials preferably have a softening point of from 40° C. to 120° C. and a melting point of from 60° C. to 150° C., and more preferably a softening point of from 40° C. to 100° C. and a melting point of from 60° C. to 120° C. The melting point less than 60° C. has a problem in storage stability and the melting point exceeding 150° C. lowers ink receptive sensitivity.

Materials usable include paraffin, polyolefin, polyethylene wax, microcrystalline wax, and fatty acid wax. The molecular weight thereof is approximately from 800 to 10,000. A polar group such as a hydroxyl group, an ester group, a carboxyl group, an aldehyde group and a peroxide group may be introduced into the wax by oxidation to increase the emulsification ability. Moreover, stearoamide, linolenamide, laurylamide, myristylamide, hardened cattle fatty acid amide, parmitylamide, oleylamide, rice bran oil fatty acid amide, palm oil fatty acid amide, a methylol compound of the above-mentioned amide compounds, methylenebissteastearoamide and ethylenebissteastearoamide may be added to the wax to lower the softening point or to raise the working efficiency. A cumarone-indene resin, a rosin-modified phenol resin, a terpene-modified phenol resin, a xylene resin, a ketone resin, an acryl resin, an ionomer and a copolymer of these resins may also be usable.

Among them, polyethylene, microcrystalline wax, fatty acid ester and fatty acid are preferably contained. A high sensitive image formation can be performed since these materials each have a relative low melting point and a low melt viscosity. These materials each have a lubrication ability. Accordingly, even when a shearing force is applied to the surface layer of the printing plate precursor, the layer damage is minimized, and resistance to contaminations which may be caused by scratch is further enhanced.

The heat melting particles are preferably dispersible in water. The average particle size thereof is preferably from 0.01 to 10 μm, and more preferably from 0.05 to 3 μm. When a layer containing the heat melting particles is coated on a porous hydrophilic layer described later, the particles having an average particle size less than 0.01 μm may enter the pores of the hydrophilic layer or the valleys between the neighboring two peaks on the hydrophilic layer surface, resulting in insufficient on press development and background contaminations. The particles having an average particle size exceeding 10 μm may result in lowering of dissolving power.

The composition of the heat melting particles may be continuously varied from the interior to the surface of the particles. The particles may be covered with a different material. Known microcapsule production method or sol-gel method can be applied for covering the particles.

The heat melting particle content of the layer is preferably 1 to 90% by weight, and more preferably 5 to 80% by weight based on the total layer weight.

(Heat Fusible Particles)

The heat fusible particles in the invention include thermoplastic hydrophobic polymer particles. Although there is no specific limitation to the upper limit of the softening point of the thermoplastic hydrophobic polymer particles, the softening point is preferably lower than the decomposition temperature of the polymer particles. The weight average molecular weight (Mw) of the polymer is preferably within the range of from 10,000 to 1,000,000.

Examples of the polymer consistituting the polymer particles include a diene (co)polymer such as polypropylene, polybutadiene, polyisoprene or an ethylene-butadiene copolymer; a synthetic rubber such as a styrene-butadiene copolymer, a methyl methacrylate-butadiene copolymer or an acrylonitrile-butadiene copolymer; a (meth)acrylate (co)polymer or a (meth)acrylic acid (co)polymer such as polymethyl methacrylate, a methyl methacrylate-(2-ethylhexyl)acrylate copolymer, a methyl methacrylate-methacrylic acid copolymer, or a methyl acrylate-(N-methylolacrylamide); polyacrylonitrile; a vinyl ester (co)polymer such as a polyvinyl acetate, a vinyl acetate-vinyl propionate copolymer and a vinyl acetate-ethylene copolymer, or a vinyl acetate-2-hexylethyl acrylate copolymer; and polyvinyl chloride, polyvinylidene chloride, polystyrene and a copolymer thereof. Among them, the (meth)acrylate polymer, the (meth)acrylic acid (co)polymer, the vinyl ester (co)polymer, the polystyrene and the synthetic rubbers are preferably used.

The polymer particles may be prepared from a polymer synthesized by any known method such as an emulsion polymerization method, a suspension polymerization method, a solution polymerization method and a gas phase polymerization method. The particles of the polymer synthesized by the solution polymerization method or the gas phase polymerization method can be produced by a method in which an organic solution of the polymer is sprayed into an inactive gas and dried, and a method in which the polymer is dissolved in a water-immiscible solvent, then the resulting solution is dispersed in water or an aqueous medium and the solvent is removed by distillation. In both of the methods, a surfactant such as sodium lauryl sulfate, sodium dodecylbenzenesulfate or polyethylene glycol, or a water-soluble resin such as poly(vinyl alcohol) may be optionally used as a dispersing agent or stabilizing agent.

The heat fusible particles are preferably dispersible in water. The average particle size of the heat fusible particles is preferably from 0.01 to 10 μm, and more preferably from 0.1 to 3 μm. When a layer containing the heat fusible particles having an average particle size less than 0.01 μm is coated on the porous hydrophilic layer, the particles may enter the pores of the hydrophilic layer or the valleys between the neighboring two peaks on the hydrophilic layer surface, resulting in insufficient on press development and background contaminations. The heat fusible particles having an average particle size exceeding 10 μm may result in lowering of dissolving power.

Further, the composition of the heat fusible particles may be continuously varied from the interior to the surface of the particles. The particles may be covered with a different material. As a covering method, known methods such as a microcapsule method and a sol-gel method are usable.

The heat fusible particle content of the layer is preferably from 1 to 90% by weight, and more preferably from 5 to 80% by weight based on the total weight of the layer.

It is preferred that the image formation layer in the invention contains a light-heat conversion material.

The dry coating amount of the image formation layer is preferably from 0.10 to 1.50 g/m², and more preferably from 0.15 to 1.00 g/m².

[Hydrophilic Layer]

In the invention, it is preferred that the printing plate material comprises at least one hydrophilic layer between the support and the foregoing adhesion layer.

Next, the hydrophilic layer in the invention will be explained. The hydrophilic layer is defined as a layer exhibiting high repellency to ink and high affinity to water in the printing plate material.

In the invention, at least one hydrophilic layer provided on the support preferably has a porous structure. In order to form the hydrophilic layer having such a porous structure, materials described later forming a hydrophilic matrix phase are used. Material for forming a hydrophilic matrix phase is preferably a metal oxide.

(Metal Oxide)

The metal oxide preferably comprises metal oxide particles. Examples of the metal oxide particles include particles of colloidal silica, alumina sol, titania sol and another metal oxide sol. The metal oxide particles may have any shape such as spherical, needle-like, and feather-like shape. The average particle size is preferably from 3 to 100 nm, and plural kinds of metal oxide each having a different size may be used in combination. The surface of the particles may be subjected to surface treatment.

The metal oxide particles can be used as a binder, utilizing its layer forming ability. The metal oxide particles are suitably used in a hydrophilic layer since they minimize lowering of the hydrophilicity of the layer as compared with an organic compound binder.

(Colloidal Silica)

Among the above-mentioned, colloidal silica is particularly preferred. The colloidal silica has a high layer forming ability under a drying condition with a relative low temperature, and can provide a good layer strength. It is preferred that the colloidal silica used in the invention is necklace-shaped colloidal silica or colloidal silica particles having an average particle size of not more than 20 nm, each being described later. Further, it is preferred that the colloidal silica provides an alkaline colloidal silica solution as a colloid solution.

The necklace-shaped colloidal silica to be used in the invention is a generic term of an aqueous dispersion system of a spherical silica having a primary particle size of the order of nm. The necklace-shaped colloidal silica to be used in the invention means a “pearl necklace-shaped” colloidal silica formed by connecting spherical colloidal silica particles each having a primary particle size of from 10 to 50 μm so as to attain a length of from 50 to 400 nm. The term of “pearl necklace-shaped” means that the image of connected colloidal silica particles is like to the shape of a pearl necklace.

The bonding between the silica particles forming the necklace-shaped colloidal silica is considered to be —Si—O—Si—, which is formed by dehydration of —SiOH groups located on the surface of the silica particles. Concrete examples of the necklace-shaped colloidal silica include Snowtex-PS series produced by Nissan Kagaku Kogyo, Co., Ltd. As the products, there are Snowtex-PS-S (the average particle size in the connected state is approximately 110 nm), Snowtex-PS-M (the average particle size in the connected state is approximately 120 nm) and Snowtex-PS-L (the average particle size in the connected state is approximately 170 nm). Acidic colloidal silicas corresponding to each of the above-mentioned are Snowtex-PS-S-O, Snowtex-PS-M-O and Snowtex-PS-L-O, respectively.

The necklace-shaped colloidal silica is preferably used in a hydrophilic layer as a porosity providing material for hydrophilic matrix phase, and porosity and strength of the layer can be secured by its addition to the layer. Among them, the use of Snowtex-PS-S, Snowtex-PS-M or Snowtex-PS-L, each being alkaline colloidal silica particles, is particularly preferable since the strength of the hydrophilic layer is increased and occurrence of background contamination is inhibited even when a lot of prints are printed.

It is known that the binding force of the colloidal silica particles is become larger with decrease of the particle size. The average particle size of the colloidal silica particles to be used in the invention is preferably not more than 20 nm, and more preferably 3 to 15 nm.

As above-mentioned, the alkaline colloidal silica particles show the effect of inhibiting occurrence of the background contamination. Accordingly, the use of the alkaline colloidal silica particles is particularly preferable. Examples of the alkaline colloidal silica particles having the average particle size within the foregoing range include Snowtex-20 (average particle size: 10 to 20 nm), Snowtex-30 (average particle size: 10 to 20 nm), Snowtex-40 (average particle size: 10 to 20 nm), Snowtex-N (average particle size: 10 to 20 nm), Snowtex-S (average particle size: 8 to 11 nm) and Snowtex-XS (average particle size: 4 to 6 nm), each produced by Nissan Kagaku Co., Ltd.

The colloidal silica particles having an average particle size of not more than 20 nm, when used together with the necklace-shaped colloidal silica as described above, is particularly preferred, since porosity of the layer is maintained and the layer strength is further increased.

The ratio of the colloidal silica particles having an average particle size of not more than 20 nm to the necklace-shaped colloidal silica is preferably from 95/5 to 5/95, more preferably from 70/30 to 20/80, and most preferably from 60/40 to 30/70.

The hydrophilic layer of the printing plate precursor of the invention contains porous metal oxide particles having a particle size of less than 1 μm as metal oxides.

(Porous Metal Oxide Particles)

Examples of the porous metal oxide particles include porous silica particles, porous aluminosilicate particles or zeolite particles as described later.

(Porous Silica or Porous Aluminosilicate Particles)

The porous silica particles are ordinarily produced by a wet method or a dry method. By the wet method, the porous silica particles can be obtained by drying and pulverizing a gel prepared by neutralizing an aqueous silicate solution, or pulverizing the precipitate formed by neutralization. By the dry method, the porous silica particles are prepared by combustion of silicon tetrachloride together with hydrogen and oxygen to precipitate silica. The porosity and the particle size of such particles can be controlled by variation of the production conditions. The porous silica particles prepared from the gel by the wet method is particularly preferred.

The porous aluminosilicate particles can be prepared by the method described in, for example, JP O.P.I. No. 10-71764. Thus prepared aluminosilicate particles are amorphous complex particles synthesized by hydrolysis of aluminum alkoxide and silicon alkoxide as the major components. The particles can be synthesized so that the ratio of alumina to silica in the particles is within the range of from 1:4 to 4:1.

Complex particles composed of three or more components prepared by an addition of another metal alkoxide may also be used in the invention. In such a particle, the porosity and the particle size can be controlled by adjustment of the production conditions.

The porosity of the particles is preferably not less than 1.0 ml/g, more preferably not less than 1.2 ml/g, and most preferably of from 1.8 to 2.5 ml/g, in terms of pore volume. The pore volume is closely related to water retention of the coated layer. As the pore volume increases, the water retention is increased, contamination is difficult to occur, and the water retention latitude is broad. Particles having a pore volume of more than 2.5 ml/g are brittle, resulting in lowering of durability of the layer containing them. Particles having a pore volume of less than 0.5 ml/g may be insufficient in printing performance.

(Measurement of Pore Volume)

Measurement of the pore volume is carried out employing AUTOSORB-1 produced by Quantachrome Co., Ltd. Assuming that the voids of particles are filled with a nitrogen gas, the pore volume is calculated from a nitrogen gas adsorption amount at a relative pressure of 0.998.

(Zeolite Particles)

Zeolite is a crystalline aluminosilicate, which is a porous material having voids of a regular three dimensional net work structure and having a pore diameter of 0.3 to 1 nm. Natural and synthetic zeolites are expressed by the following formula.
(M₁.(M₂)_{0.5})ₘ(AlₘSiₙO₂₍ₘ₊ₙ₎).xH₂O

In the above, M₁ and M₂ are each exchangeable cations. Examples of M₁ include Li⁺, Na⁺, K⁺, Tl⁺, Me₄N⁺ (TMA), Et₄N⁺ (TEA), Pr₄N⁺ (TPA), C₇H₁₅N²⁺, and C₈H₁₆N⁺, and examples of M² include Ca²⁺, Mg²⁺, Ba²⁺, Sr²⁺ and C₈H₁₈N₂²⁺. Relation of n and m is n≧m, and consequently, the ratio of m/n, or that of Al/Si is not more than 1. A higher Al/Si ratio shows a higher content of the exchangeable cation, and a higher polarity, resulting in higher hydrophilicity. The Al/Si ratio is within the range of preferably from 0.4 to 1.0, and more preferably 0.8 to 1.0. x is an integer.

Synthetic zeolite having a stable Al/Si ratio and a sharp particle size distribution is preferably used as the zeolite particles to be used in the invention. Examples of such zeolite include Zeolite A: Na₁₂(Al₁₂Si₁₂O₄₈).27H₂O; Al/Si=1.0, Zeolite X: Na₈₆(Al₈₆Si₁₀₆O₃₈₄).264H₂O; Al/Si=0.811, and Zeolite Y: Na₅₆(Al₅₆Si₁₃₆O₃₈₄).250H₂O; Al/Si=0.412.

Containing the porous zeolite particles having an Al/Si ratio within the range of from 0.4 to 1.0 in the hydrophilic layer greatly raises the hydrophilicity of the hydrophilic layer itself, whereby contamination in the course of printing is inhibited and the water retention latitude is also increased. Further, contamination caused by a finger mark is also greatly reduced. When Al/Si is less than 0.4, the hydrophilicity is insufficient and the above-mentioned improving effects are lowered.

The hydrophilic matrix phase constituting the hydrophilic layer in the invention can contain layer structural clay mineral particles as a metal oxide. Examples of the layer structural clay mineral particles include a clay mineral such as kaolinite, halloysite, talk, smectite such as montmorillonite, beidellite, hectorite and saponite, vermiculite, mica and chlorite; hydrotalcite; and a layer structural polysilicate such as kanemite, makatite, ilerite, magadiite and kenyte. Among them, ones having a higher electric charge density of the unit layer are higher in the polarity and in the hydrophilicity. Preferable charge density is not less than 0.25, more preferably not less than 0.6. Examples of the layer structural mineral particles having such a charge density include smectite having a negative charge density of from 0.25 to 0.6 and bermiculite having a negative charge density of from 0.6 to 0.9. Synthesized fluorinated mica is preferable since one having a stable quality, such as the particle size, is available. Among the synthesized fluorinated mica, swellable one is preferable and one freely swellable is more preferable.

An intercalation compound of the foregoing layer structural mineral particles such as a pillared crystal, or one treated by an ion exchange treatment or a surface treatment such as a silane coupling treatment or a complication treatment with an organic binder is also usable.

With respect to the size of the planar structural mineral particles, the particles have an average particle size (an average of the largest particle length) of preferably not more than 20 μm, and more preferably not more than 10 μm, and an average aspect ratio (the largest particle length/the particle thickness of preferably not less than 20, and more preferably not less than 50, in a state contained in the layer including the case that the particles are subjected to a swelling process and a dispersing layer-separation process. When the particle size is within the foregoing range, continuity to the parallel direction, which is a trait of the layer structural particle, and softness, are given to the coated layer so that a strong dry layer in which a crack is difficult to be formed can be obtained. The coating solution containing the layer structural clay mineral particles in a large amount can minimize particle sedimentation due to a viscosity increasing effect. The particle size greater than the foregoing may produce a non-uniform coated layer, resulting in poor layer strength. The aspect ratio lower than the foregoing reduces the planar particles, resulting in insufficient viscosity increase and reduction of particle sedimentation inhibiting effect.

The content of the layer structural clay mineral particles is preferably from 0.1 to 30% by weight, and more preferably from 1 to 10% by weight based on the total weight of the layer. Particularly, the addition of the swellable synthesized fluorinated mica or smectite is effective if the adding amount is small. The layer structural clay mineral particles may be added in the form of powder to a coating liquid, but it is preferred that gel of the particles which is obtained by being swelled in water, is added to the coating liquid in order to obtain a good dispersity according to an easy coating liquid preparation method which requires no dispersion process comprising dispersion due to media.

An aqueous solution of a silicate is also usable as another additive to the hydrophilic matrix phase. An alkali metal silicate such as sodium silicate, potassium silicate or lithium silicate is preferable, and the SiO₂/M₂O is preferably selected so that the pH value of the coating liquid after addition of the silicate exceeds 13 in order to prevent dissolution of the porous metal oxide particles or the colloidal silica particles.

An inorganic polymer or an inorganic-organic hybrid polymer prepared by a sol-gel method employing a metal alkoxide. Known methods described in S. Sakka “Application of Sol-Gel Method” or in the publications cited in the above publication can be applied to prepare the inorganic polymer or the inorganic-organic hybridpolymer by the sol-gel method.

A water soluble resin may be contained in the hydrophilic layer in the invention. Examples of the water soluble resin include polysaccharides, polyethylene oxide, polypropylene oxide, polyvinyl alcohol, polyethylene glycol (PEG), polyvinyl ether, a styrene-butadiene copolymer, a conjugation diene polymer latex of methyl methacrylate-butadiene copolymer, an acryl polymer latex, a vinyl polymer latex, polyacrylamide, and polyvinyl pyrrolidone. In the invention, polysaccharides are preferably used as the water soluble resin.

As the polysaccharide, starches, celluloses, polyuronic acid and pullulan can be used. Among them, a cellulose derivative such as a methyl cellulose salt, a carboxymethyl cellulose salt or a hydroxyethyl cellulose salt is preferable, and a sodium or ammonium salt of carboxymethyl cellulose is more preferable. These polysaccharides can form a preferred surface shape of the hydrophilic layer.

The surface of the hydrophilic layer preferably has a convexoconcave structure having a pitch of from 0.1 to 50 μm such as the grained aluminum surface of an aluminum PS plate. The water retention ability and the image maintaining ability are raised by such a convexoconcave structure of the surface. Such a convexoconcave structure can also be formed by adding in an appropriate amount a filler having a suitable particle size to the coating liquid of the hydrophilic layer. However, the convexoconcave structure is preferably formed by coating a coating liquid for the hydrophilic layer containing the alkaline colloidal silica and the water-soluble polysaccharide so that the phase separation occurs at the time of drying the coated liquid, whereby a structure is obtained which provides a good printing performance.

The shape of the convexoconcave structure such as the pitch and the surface roughness thereof can be suitably controlled by the kinds and the adding amount of the alkaline colloidal silica particles, the kinds and the adding amount of the water-soluble polysaccharide, the kinds and the adding amount of another additive, a solid concentration of the coating liquid, a wet layer thickness or a drying condition.

In the invention, it is preferred that the water soluble resin contained in the hydrophilic matrix phase is water soluble, and at least a part of the resin exists in the hydrophilic layer in a state capable of being dissolved in water. If a water soluble carbon atom-containing material is cross-linked by a cross-linking agent and is insoluble in water, its hydrophilicity is lowered, resulting in problem of lowering printing performance. A cationic resin may also be contained in the hydrophilic layer. Examples of the cationic resin include a polyalkylene-polyamine such as a polyethyleneamine or polypropylenepolyamine or its derivative, an acryl resin having a tertiary amino group or a quaternary ammonium group and diacrylamine. The cationic resin may be added in a form of fine particles. Examples of such particles include the cationic microgel described in Japanese Patent O.P.I. Publication No. 6-161101.

A water-soluble surfactant may be added for improving the coating ability of the coating liquid for the hydrophilic layer in the invention. A silicon atom-containing surfactant and a fluorine atom-containing surfactant are preferably used. The silicon atom-containing surfactant is especially preferred in that it minimizes printing contamination. The content of the surfactant is preferably from 0.01 to 3% by weight, and more preferably from 0.03 to 1% by weight based on the total weight of the hydrophilic layer (or the solid content of the coating liquid).

The hydrophilic layer in the invention can contain a phosphate. Since a coating liquid for the hydrophilic layer is preferably alkaline, the phosphate to be added to the hydrophilic layer is preferably sodium phosphate or sodium monohydrogen phosphate. The addition of the phosphate provides improved reproduction of dots at shadow portions. The content of the phosphate is preferably from 0.1 to 5% by weight, and more preferably from 0.5 to 2% by weight in terms of amount excluding hydrated water.

[Light-Heat Conversion Material]

The image formation layer, hydrophilic layer, hydrophilic overcoat layer or another layer in the invention can contain a light-heat conversion material. Examples of the light-heat conversion material include the following substances:

(Infrared Absorbing Dye)

Examples of the light-heat conversion material include a general infrared absorbing dye such as a cyanine dye, a chloconium dye, a polymethine dye, an azulenium dye, a squalenium dye, a thiopyrylium dye, a naphthoquinone dye or an anthraquinone dye, and an organometallic complex such as a phthalocyanine compound, a naphthalocyanine compound, an azo compound, a thioamide compound, a dithiol compound or an indoaniline compound. Exemplarily, the light-heat conversion materials include compounds disclosed in Japanese Patent O.P.I. Publication Nos. 63-139191, 64-33547, 1-160683, 1-280750, 1-293342, 2-2074, 3-26593, 3-30991, 3-34891, 3-36093, 3-36094, 3-36095, 3-42281, 3-97589 and 3-103476. These compounds may be used singly or in combination.

Examples of pigment include carbon, graphite, a metal and a metal oxide.

Furnace black and acetylene black is preferably used as the carbon. The graininess (d₅₀) thereof is preferably not more than 100 nm, and more preferably not more than 50 nm.

The graphite is one having a particle size of preferably not more than 0.5 μm, more preferably not more than 100 nm, and most preferably not more than 50 nm.

As the metal, any metal can be used as long as the metal is in a form of fine particles having preferably a particle size of not more than 0.5 μm, more preferably not more than 100 nm, and most preferably not more than 50 nm. The metal may have any shape such as spherical, flaky and needle-like. Colloidal metal particles such as those of silver or gold are particularly preferred.

As the metal oxide, materials having black color in the visible regions, or electro-conductive materials or semi-conductive materials can be used. Examples of the materials having black color in the visible regions include black iron oxide (Fe₃O₄), and black complex metal oxides containing at least two metals. Black complex metal oxides comprised of at least two metals are preferred. Typically, the black complex metal oxides include complex metal oxides comprising at least two selected from Al, Ti, Cr, Mn, Fe, Co, Ni, Cu, Zn, Sb, and Ba. These can be prepared according to the methods disclosed in Japanese Patent O.P.I. Publication Nos. 9-27393, 9-25126, 9-237570, 9-241529 and 10-231441. The complex metal oxide used in the invention is preferably a complex Cu—Cr—Mn type metal oxide or a Cu—Fe—Mn type metal oxide. The Cu—Cr—Mn type metal oxides are preferably subjected to the treatment disclosed in Japanese Patent O.P.I. Publication Nos. 8-27393 in order to reduce isolation of a 6-valent chromium ion. These complex metal oxides have a high color density and a high light-heat conversion efficiency as compared with another metal oxide. The primary average particle size of these complex metal oxides is preferably from 0.001 to 1.0 μm, and more preferably from 0.01 to 0.5 μm. The primary average particle size of from 0.001 to 1.0 μm improves a light-heat conversion efficiency relative to the addition amount of the particles, and the primary average particle size of from 0.05 to 0.5 μm further improves a light-heat conversion efficiency relative to the addition amount of the particles. The light-heat conversion efficiency relative to the addition amount of the particles depends on a dispersity of the particles, and the well-dispersed particles have a high light-heat conversion efficiency. Accordingly, these complex metal oxide particles are preferably dispersed according to a known dispersing method, separately to a dispersion liquid (paste), before being added to a coating liquid for the particle containing layer. The metal oxides having a primary average particle size of less than 0.001 are not preferred since they are difficult to disperse. A dispersant is optionally used for dispersion. The addition amount of the dispersant is preferably from 0.01 to 5% by weight, and more preferably from 0.1 to 2% by weight, based on the weight of the complex metal oxide particles. Kinds of the dispersant are not specifically limited, but the dispersant is preferably a silicon-contained surfactant.

Examples of the electro-conductive materials or semi-conductive materials include Sb-doped SnO₂ (ATO), Sn-added In₂O₃ (ITO), TiO₂, TiO prepared by reducing TiO₂ (titanium oxide nitride, generally titanium black). Particles prepared by covering a core material such as BaSO₄, TiO₂, 9Al₂O₃. 2B₂O and K₂O.nTiO₂ with these metal oxides is usable. The particle size of these particles is preferably not more than 0.5 μm, more preferably not more than 100 nm, and most preferably not more than 50 nm.

The especially preferred light-heat conversion materials are the above-described infrared absorbing dyes or the black complex metal oxides comprised of at least two metal oxides.

The addition amount of the light-heat conversion materials is preferably 0.1 to 50% by weight, more preferably 1 to 30% by weight, and most preferably 3 to 25% by weight based on the weight of the layer to which the material are added.

(Hydrophilic Overcoat Layer)

In the invention, a hydrophilic overcoat layer is preferably provided on the image formation layer, in order to prevent flaws from occurring during handling. The hydrophilic overcoat layer may be provided directly or through an intermediate layer on the image formation layer. It is preferred that the hydrophilic overcoat layer can be removed on a printing press.

Examples of the water soluble resin include polysaccharides, polyethylene oxide, polypropylene oxide, polyvinyl alcohol, polyethylene glycol (PEG), polyvinyl ether, a styrene-butadiene copolymer, a conjugation diene polymer latex of methyl methacrylate-butadiene copolymer, an acryl polymer latex, a vinyl polymer latex, polyacrylamide, and polyvinyl pyrrolidone. In the invention, polysaccharides are preferably used as the water soluble resin. As the polysaccharide, starches, celluloses, polyuronic acid and pullulan can be used. Among them, a cellulose derivative such as a methyl cellulose salt, a carboxymethyl cellulose salt or a hydroxyethyl cellulose salt is preferable, and a sodium or ammonium salt of carboxymethyl cellulose is more preferable.

In the invention, the hydrophilic overcoat layer can contains a light-heat conversion material described before.

The overcoat layer in the invention preferably contains a matting agent with an average size of from 1 to 20 μm, in order to prevent flaws from occurring while the printing plate material is mounted on a laser apparatus or on a printing press.

The matting agent is preferably inorganic particles having a new Mohs hardness of not less than 5 or an organic matting agent. Examples of the inorganic particles having a new Mohs hardness of not less than 5 include particles of metal oxides (for example, silica, alumina, titania, zirconia, iron oxides, chromium oxide), particles of metal carbides (for example, silicon carbide), boron nitride particles, and diamond particles. Examples of the organic matting agent include starch described in U.S. Pat. No. 2,322,037, starch derivatives described in BE 625,451 and GB 981,198, Polyvinyl alcohol described in JP-B-44-3643, polystyrene or polymethacrylate described in CH 330,158, polyacrylonitrile described in US Patent No. 3,079,257, and polycarbonate described in U.S. Pat. No. 3,022,169. The adding amount of the matting agent in the overcoat layer is preferably from 0.1 g to less than 10 g per m².

A coating solution for the overcoat layer may contain a nonionic surfactant in order to secure uniform coatability of the overcoat layer. Examples of the nonionic surfactant include sorbitan tristearate, sorbitan monopalmitate, sorbitan trioleate, stearic acid monoglyceride, polyoxyethylenenonylphenyl ether, and polyoxyethylenedodecyl ether. The content of the nonionic surfactant is preferably 0.05 to 5% by weight, and more preferably 1 to 3% by weight based on the total solid content of the overcoat layer.

In the invention, the dry thickness of the overcoat layer is preferably 0.05 to 1.5 g/m², and more preferably 0.1 to 0.7 g/m². This content range prevents occurrence of staining or scratches or deposition of fingerprints, and minimizes ablation scum without impairing removability of the overcoat layer.

(Visibility)

Before a printing plate with an image is mounted on a printing press for printing, there is usually a plate inspection process for examining if the image is correctly formed on the printing plate. When the plate inspection process is carried out, it is preferred that a printing plate before printing has a property in which an image formed on the printing plate is visible, that is, image visibility. Since the printing plate material of the invention is a processless printing plate material capable of carrying out printing without special development, it is preferred that the optical density of exposed portions in the printing plate material varies by light or heat generated on exposure.

As a method for providing image visibility to a printing plate material in the invention, there is a method employing a cyanine type infrared light absorbing dye, which varies its optical density on exposure, a method employing a combination of a photo-induced acid generating agent and a compound varying its color by an acid, a method employing a combination of a color forming agent such as a leuco dye and a color developing agent, or a method employing a function in which the foregoing devitrified and milky-white heat melting particles or heat fusible particles before exposure of light are trasparentized by exposure.

(Packaging Material)

The printing plate material manufactured above was cut into an intended size, packed in a packaging material and stored till the material is subjected to exposure for image formation as described later. It is preferred that the printing plate material is wound around a core having a diameter of 4 to 10 cm so as to form a printing plate material roll. In order to endure a long term storage, the packaging material is preferably one having an oxygen permeability of not more than 50 ml/atm·m²·30° C.·day as disclosed in Japanese Patent O.P.I. Publication No. 2000-206653. As another embodiment, the packaging material is also preferred which has a moisture permeability of not more than 10 g/atm·m²·25° C.·day as disclosed in Japanese Patent O.P.I. Publication No. 2000-206653.

(Exposure)

The image formation on the printing plate material of the invention is obtained preferably by laser exposure applied from the surface having the image formation layer.

Exposure applied in the invention is preferably scanning exposure, which is carried out employing a laser which can emit light having a wavelength of infrared and/or near-infrared regions, that is, a wavelength of from 700 to 1500 nm. As the laser, a gas laser can be used, but a semi-conductor laser, which emits light having a near-infrared region wavelength, is preferably used.

A device suitable for the scanning exposure in the invention may be any device capable of forming an image on the printing plate material according to image signals from a computer employing a semi-conductor laser.

Generally, the following scanning exposure processes are mentioned.

(1) A process in which a plate precursor provided on a fixed horizontal plate is scanning exposed in two dimensions, employing one or several laser beams.

(2) A process in which the surface of a plate precursor provided along the inner peripheral wall of a fixed cylinder is subjected to scanning exposure in the rotational direction (in the main scanning direction) of the cylinder, employing one or several lasers located inside the cylinder, moving the lasers in the normal direction (in the sub-scanning direction) to the rotational direction of the cylinder.

(3) A process in which the surface of a plate precursor provided along the outer peripheral wall of a fixed cylinder is subjected to scanning exposure in the rotational direction (in the main scanning direction) of the cylinder, employing one or several lasers located inside the cylinder, moving the lasers in the normal direction (in the sub-scanning direction) to the rotational direction of the cylinder.

In the invention, the process (3) above is preferable, and especially preferable when a printing plate material mounted on a plate cylinder of a printing press is scanning exposed.

Employing the thus printing plate material after image recording, printing is carried out without a special development process. After the printing plate material is imagewise exposed and mounted on a plate cylinder of a printing press, or after the printing plate material is mounted on the cylinder and then imagewise heated to obtain a printing plate material, a dampening water supply roller and/or an ink supply roller are brought into contact with the surface of the resulting printing plate material while rotating the plate cylinder to remove non-image portions of the component layer of the printing plate material (so-called, development on press).

The non-image portion removal after image recording as described above in the printing plate material of the invention can be carried out in the same sequences as in conventional PS plates. This means that processing time is shortened due to so-called development on press, resulting in lowering of cost.

It is preferred that the printing method of the invention comprises a step of drying a printing plate material, between the image recording (formation) step and a step of contacting a dampening water supply roller and/or an ink supply roller with the surface of the printing plate material. In the printing method of the invention, it is considered that the image strength gradually increases immediately after the image recording. As the conventional image recording method employing a conventional external thermal laser drum method (the process (3) above) requires about 3 minute exposure time, it has problem in that there is a difference in image strength between an image recorded at the beginning of the exposure and an image recorded at the completion of the exposure. The drying step described above can minimize such an image strength difference.

### EXAMPLE

The present invention will be detailed employing the following examples, but the invention is not limited thereto.

### Example 1

<<Preparation of Polyethylene Terephthalate Support>>

(Support 1: Polyethylene Terephthalate Support having an Adhesion Layer)

An unstretched film sheet was obtained by extruding the melted polyester (intrinsic viscosity of 0.62) composed of a terephthalic acid component and an ethylene glycol component onto a rotating drum which is cooled at 20° C. Next, after the unstretched film sheet was stretched in the mechanical direction by a stretching magnification of 3.6, a water-based liquid (solid concentration of 4% by weight) with the composition of 65% by weight of copolyester (Tg=30° C.) composed of an acid component having terephthalic acid (60 mol %), isophthalic acid (36 mol %) and 5-Na sulfo isophthalic acid (4 mol %), and a glycol component having ethylene glycol (60 mol %) and neopentylene glycol (40 mol %), 16% by weight of polyvinyl alcohol having a saponification degree of from 86 to 89 mol %, 10% by weight of cross-linked acryl resin particles having an average particle size of 40 nm, and 9% by weight of polyoxyethylene lauryl ether was coated as an adhesion layer by a roll coater.

Successively, the longitudinally stretched film sheet, on which the water-based liquid was coated, was stretched by a stretching magnification of 4 in the transverse direction while drying. A biaxially stretched film sheet having an average thickness of 175 μm was obtained further by thermally fixing the film sheet at 230° C. the thickness of adhesion layer in this film sheet was 0.03 μm, and the center line average surface roughness (Ra) and the surface energy were 15 nm and 6×10⁻⁴ N/cm, respectively. The thermal shrinkage was 0.9% in the longitudinal direction, and was 0.2% in the transverse direction.

(Support 2: Polyethylene Terephthalate Support)

An unstretched film sheet was obtained by extruding the melted polyester (intrinsic viscosity of 0.62) composed of a terephthalic acid component and an ethylene glycol component onto a rotating drum which is cooled at 20° C. Next, after the unstretched film sheet was stretched in the mechanical direction by a stretching magnification of 3.6, the longitudinally stretched film sheet was stretched by a stretching magnification of 4 in the transverse direction while drying, and a biaxially stretched film sheet having an average thickness of 175 μm was obtained further by thermally fixing the film sheet at 230° C.

The both surfaces of the film on support 2 prepared above were subjected to corona discharge treatment at 8 W/m² minute. Subsequently, the following subbing layer coating solution “a” was coated on one side of the support to give a first subbing layer with a dry thickness of 0.8 μm, and further, the following subbing layer coating solution “b” was coated on the resulting layer to give a second subbing layer with a dry thickness of 0.1 μm, while carrying out corona discharge treatment (at 8 W/m²·minute), each layer being dried at 180° C. for 4 minutes. (The surface of the thus obtained subbing layer was designated as subbing layer surface A.)

<<Subbing Layer Coating Solution “a”>>

| | |
|---|---|
| Latex of styrene/glycidyl methacrylate/butyl acrylate | 6.3% |
| (60/39/1) copolymer (Tg = 75° C.) | |
| (in terms of solid content) | |
| Latex of styrene/glycidyl methacrylate/butyl acrylate | 1.6% |
| (20/40/40) copolymer | |
| (in terms of solid content) | |
| Anionic surfactant s-1 | 0.1% |
| Water | 92.0% |

<<Subbing Layer Coating Solution “b”>>

| | |
|---|---|
| Gelatin | 1% |
| Anionic surfactant S-1 | 0.05% |
| Hardener H-1 | 0.02% |
| Matting agent (Silica particles with an average particle size of | 0.02% |
| 3.5 μm) | |
| Antifungal agent F-1 | 0.01% |
| Water | 98.9% |

S-1

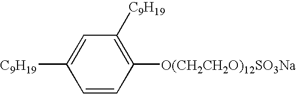

H-1

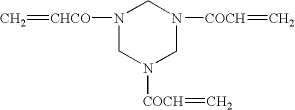

F-1

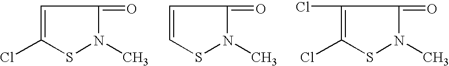

<<Heat Treatment of Subbed Support>>

The support was slit to obtain a width of 1.25 m, and subjected to heat treatment (low tension heat treatment) at a tension of 2 hPa at 180° C. for one minute.

<<Preparation of Printing Plate Material>>

The support 2 having a subbing layer was dried at 100° C. for 30 seconds, and covered with a moisture proof sheet so as not to contact moisture in air to obtain a covered support 2. The moisture content of support 2 was measured to be 0.2%. The covered support 2, immediately after uncovered, was coated with a hydrophilic layer.

A hydrophilic layer 1 coating solution shown in Table 1 (the preparation method will be described later) and a hydrophilic layer 2 coating solution shown in Table 2 (the preparation method will be described later) were coated on the subbing layer A of supports 1 and 2 with a wire bar. They are dried at 120° C. for 3 minutes, and further heat treated at 60° C. for 24 hours. Thereafter, the image formation layer shown in Table 3 was coated with a wire bar on the resulting hydrophilic layer dried at 50° C. for 3 minutes, and further subjected to seasoning treatment at 50° C. for 72 hours. Thus, printing plate materials 101 and 102 were prepared.

(Preparation of Hydrophilic Layer 1 Coating Solution)

The materials as shown in Table 1 were sufficiently mixed in the amounts shown in Table 1 while stirring, employing a homogenizer, and filtered, diluted with pure water and dispersed to obtain hydrophilic layer 1 coating solution. In Table 1, numerical values represent solid content by weight per m².

TABLE 1
Materials

| | | |
|---|---|---|
| Colloidal silica (alkali type): Snowtex XS (solid 20% | 1.2 | g |
| by weight, produced by Nissan Kagaku Co., Ltd.) | | |
| Colloidal silica (alkali type): Snowtex ZL (solid 40% | 80 | mg |
| by weight, produced by Nissan Kagaku Co., Ltd.) | | |
| STM-6500S produced by Nissan Kagaku Co., Ltd. | 0.4 | g |
| (spherical particles comprised of melamine resin as | | |
| cores and silica as shells with an average particle | | |
| size of 6.5 μm and having a convexo-concave surface) | | |
| Cu—Fe—Mn type metal oxide black pigment: | 0.5 | g |
| TM-3550 black agueous dispersion {prepared by | | |
| dispersing TM-3550 black powder having a particle size | | |
| of 0.1 μm produced by Dainichi Seika Kogyo Co., Ltd. | | |
| in water to give a solid content of 40% by weight | | |
| (including 0.2% by weight of dispersant)} | | |
| Layer structural clay mineral particles: | 30 | mg |
| Montmorillonite Mineral Colloid MO gel prepared by | | |
| vigorously stirring montmorillonite Mineral Colloid | | |
| MO; gel produced by Southern Clay Products Co., Ltd. | | |
| (average particle size: 0.1 μm) in water in a | | |
| homogenizer to give a solid content of 5% by weight | | |
| Aqueous 4% by weight sodium carboxymethyl cellulose | 10 | mg |
| solution (Reagent produced by Kanto Kagaku Co., Ltd.) | | |
| Aqueous 10% by weight sodium phosphate · dodecahydrate | 6 | mg |
| solution (Reagent produced by Kanto Kagaku Co., Ltd.) | | |
| Porous metal oxide particles Silton JC 40 (porous | 0.3 | mg |
| aluminosilicate particles having an average particle | | |
| size of 4 μm, produced by Mizusawa Kagaku Co., Ltd.) | | |
| Silicone surfactant: FZ2161 (Nippon Unicar Co., Ltd.) | 50 | mg |

(Preparation of Hydrophilic Layer 2 Coating Solution)

The materials as shown in Table 2 were sufficiently mixed in the amounts shown in Table 2 while stirring, employing a homogenizer, and filtered, diluted with pure water and dispersed to obtain hydrophilic layer 2 coating solution. In Table 2, numerical values represent solid content by weight per m².

TABLE 2
Materials

| | | |
|---|---|---|
| Colloidal silica (alkali type): Snowtex S (solid 30% | 80 | mg |
| by weight, produced by Nissan Kagaku Co., Ltd.) | | |
| Necklace shaped colloidal silica (alkali type): | 120 | mg |
| Snowtex PSM (solid 20% by weight, produced by Nissan | | |
| Kagaku Co., Ltd.) | | |
| Colloidal silica (alkali type): MP-4540 (an average | 90 | mg |
| particle size of 0.4 μm, solid 30% by weight, produced | | |
| by Nissan Kagaku Co., Ltd.) | | |
| Cu—Fe—Mn type metal oxide black pigment: TM-3550 | 50 | mg |
| black aqueous dispersion {prepared by dispersing | | |
| TM-3550 black powder having a particle size of 0.1 μm | | |
| produced by Dainichi Seika Kogyo Co., Ltd. in water to | | |
| give a solid content of 40% by weight (including 0.2% | | |
| by weight of dispersant)} | | |
| Layer structural clay mineral particles: | 10 | mg |
| Montmorillonite Mineral Colloid MO gel prepared by | | |
| vigorously stirring montmorillonite Mineral Colloid | | |
| MO; gel produced by Southern Clay Products Co., Ltd. | | |
| (average particle size: 0.1 μm) in water in a | | |
| homogenizer to give a solid content of 5% by weight | | |
| Agueous 4% by weight sodium carboxymethyl cellulose | 6 | mg |
| solution (Reagent produced by Kanto Kagaku Co., Ltd.) | | |
| Aqueous 10% by weight sodium phosphate · dodecahydrate | 3 | mg |
| solution (Reagent produced by Kanto Kagaku Co., Ltd.) | | |
| Porous metal oxide particles Silton AMT08 (porous | 180 | mg |
| aluminosilicate particles having an average particle | | |
| size of 0.6 μm, produced by Mizusawa Kagaku Co., Ltd.) | | |
| Porous metal oxide particles Silton JC 20 (porous | 60 | mg |
| aluminosilicate particles having an average particle | | |
| size of 2 μm, produced by Mizusawa Kagaku Co., Ltd.) | | |

(Preparation of Image Formation Layer Coating Solution)

The materials for the image formation layer coating solution, which was prepared via dilution with pure water and aqueous dispersion, are shown in Table 3. In Table 3, numerical values represent solid content by weight per m².

TABLE 3
Materials

| | |
|---|---|
| Dispersion prepared by diluting with pure water | 400 mg |
| carnauba wax emulsion A118 (having a solid content of | |
| 40% by weight, the wax having an average particle | |
| size of 0.31 μm, a melting viscosity at 140° C. of 8 | |
| cps, a softening point of 65° C., and a melting point | |
| of 80° C., produced by GifuCerac Co., Ltd.) to give a | |
| solid content of 5% by weight | |
| microcrystalline wax emulsion A206 (having a solid | 150 mg |
| content of 40% by weight and the wax having an | |
| average particle size of 5 μm, produced by GifuCerac | |
| Co., Ltd.) to give a solid content of 5% by weight | |
| Trehalose (disaccharide) solution | 150 mg |
| (Treha, melting point of 97° C., produced by | |
| Hayashihara Shoji Co., Ltd., having a solid content | |
| of 10% by weight) | |
| Infrared dye 1 | 5 mg |
| Water-soluble resin of sodium polyacrylate: | 45 mg |
| AQUALIC DL522 (average molecular weight of 170,000 | |
| and solid content 30.5%, produced by Nippon Shokubai | |
| Co., Ltd.) | |

Infrared dye 1

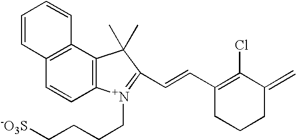

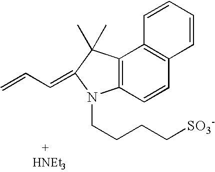

The resulting printing plate material was cut into a size of 73 cm (width)×32 m (length), and wound around a spool made of cardboard having a diameter of 7.5 cm. Thus, a printing plate sample in roll form was prepared. The resulting printing plate sample was wrapped in a 1.5 m×2 m package made of Al₂O₃PET (12 μm)/Ny (15 μm)/CPP (70 μm). The resulting wrapped material was stored at 60° C. and 60% RH for seven days. The package had an oxygen permeation of 1.7×10⁻⁵ ml/Pa·m²·30° C.·day, and a moisture permeability of 1.8×10⁻⁵ g/Pa·m²·25° C.·day.

[Evaluation of Printing Plate Material and Printing Plate]

<<Evaluation of Coating Imperfection>>

The surface of the prepared printing plate was observed to visually evaluate the coating imperfection.
Ranking 5: No coating imperfection observed.
Ranking 4: Slight coating imperfection of less than a diameter of 0.3 mm observed.
Ranking 3: Slight coating imperfection of a diameter of not less than 0.3 mm and less than 0.5 mm observed.
Ranking 2: Coating imperfection of a diameter of not less than 0.5 mm and less than 1 mm observed.
Ranking 1: Coating imperfection of a diameter of not less than 1 mm observed.
   Not more than ranking 2 indicates totally off from practical use because of defect appearance in printing.
   [Image Formation Employing Infrared Laser]

The resulting printing plate sample was cut so as to suit an exposure device, wound around an exposure drum of the exposure device and imagewise exposed. Exposure was carried out employing an infrared laser (having a wavelength of 830 nm and a laser beam spot diameter of 18 μm) at a resolution of 2,400 dpi to form an image with a screen number of 175 lines. In the exposure, the exposure energy on the image formation layer surface was varied from 150 to 350 mJ/cm² at an interval of 50 mJ/cm². (The term, “dpi” shows the number of dots per 2.54 cm.) Thus, an exposed printing plate sample with an image was obtained.

<<Printing Method>>

DAIYA 1F-1 produced by Mitsubishi Jukogyo Co., Ltd. was used as a printing press. Printing was-carried out employing coated paper sheets, dampening water 2% aqueous solution of Astromark 3 (produced by Nikken Kagaku Kenkyusho), and ink (Soybean type TK Hyeco SOY1 Magenta, produced by TOYO INK MANUFACTURING Co.). Printing was started in the same way as in printing sequence in a conventional PS plate, however, no special development was carried out on the press. After printing was completed, non-image portions of the printing plate were eliminated.

<<Evaluation of Dot Image Quality>>

Printing was carried out for 5000 copies. 2% dot image quality was visually observed in the 5000^{th} copy, employing a 100. power magnifier to evaluate the quality, introducing rankings. Ranking 5 indicates high-quality dot with no fringe, and less than ranking 3 indicates totally off from practical use, though the ranking drops simply with lowering the quality.

<<Evaluation of Initial Ink Receptivity>>

Printing was started in printing sequence in a conventional PS plate, and the number of paper sheets printed till when an image with a normal ink density was printed was counted for evaluation. The less the number is, the better the ink receptivity.

<<Evaluation of Ink Stain Elimination Property>>

Only the ink roller was bought into contact with the exposed printing plate material sample to form an ink layer on the entire surface of the sample, and then conventional printing was carried out supplying dampening water and printing ink onto the resulting sample via the dampening roller and the ink roller. The number of paper sheets printed from the beginning of conventional printing until a print without ink stain in non-image portions was obtained was counted, and evaluated as a measure of ink stain elimination property. The less the number is the better.

The results are shown in Table 4.

TABLE 4

| | | | | | Ink | |
|---|---|---|---|---|---|---|
| | | | Dot | Initial | stain | |
| | Sup- | Coating | image | ink | elimina- | |
| Sam- | port | imperfec- | quality | recep- | tion | |
| ple | used | tion | (Rank- | tivity | property | |
| No. | (No.) | (Ranking) | ing) | (number) | (number) | |
| 101 | 1 | 5 | 5 | 5 | 30 | Present |
| | | | | | | invention |
| 102 | 2 | 2 | 2 | 200 | 200 | Compara- |
| | | | | or more | | tive |

It is to be understood via Table 4 that the printing plate material in the present invention exhibits superior properties of the coating imperfection, the dot image quality, the initial ink receptivity, and the ink stain elimination in non-image portions to the comparative printing plate material.

### Example 2

[Preparation of Printing Plate Material]

Back surface layer coating solution 1 described below was coated on the opposite side of the surface, on which the image formation layer of support 1 prepared in Example 1 was coated, to give a layer with a dry thickness of 0.8 μm, and further, back surface layer coating solution 2 was coated on the resulting layer to give the layer with a dry thickness of 1.0 μm, while carrying out corona discharge treatment (at 8 W/m²·minute), each layer being dried at 180° C. for 4 minutes.

| | | |
|---|---|---|
| <<Back surface layer coating solution 1>> | | |
| Julimer ET-410 (Tg = 52° C.) | 21% | |
| (produced by Nippon Junyaku Co., Ltd.) | | |
| SnO₂/Sb (9/1 by weight) particles | 67% | |
| (average particle size: 0.25 μm) | | |
| Matting agent polymethyl methacrylate | 4% | |
| (average particle size: 5 μm) | | |
| Denacol EX-614B (produced | 7% | |
| by Nagase Kasei Kogyo Co., Ltd.) | | |
| <<Back surface layer coating solution 2>> | | |
| PVdC polymer latex (Core-shell type latex | 3,000 | parts by weight |
| containing particles comprised of 90% | | |
| by weight of core and 10% by weight of | | |
| shell, the core comprised of a copolymer | | |
| of vinylidene chloride/methyl acrylate/methyl | | |
| methacrylate/acrylonitrile/acrylic acid | | |
| {93/3/3/0.9/0.1 (% by weight)}, and | | |
| the shell comprised of a copolymer of | | |
| vinylidene chloride/methyl acrylate/methyl | | |
| methacrylate/acrylonitrile/acrylic acid | | |
| {88/3/3/3/3 (% by weight)}, the weight | | |
| average molecular weight of the copolymer | | |
| being 38,000) | | |
| 2,4-Dichloro-6-hydroxy-s-triazine | 23 | parts by weight |
| Matting agent | 1.5 | parts by weight |
| (polystyrene, average particle size of 2.4 μm) | | |

Back surface layer coating solution 3 shown in Table 5 was coated on the surface with a wire bar, and was dried at 50° C. for 3 minutes. The smoother value of the coated surface was 65 kPa.

TABLE 5
Materials

| | | |
|---|---|---|
| Colloidal silica (alkali type): Snowtex XS (solid 20% | 0.6 | g |
| by weight, produced by Nissan Kagaku Co., Ltd.) | | |
| polymethyl methacrylate (spherical particles having | 0.05 | g |
| an average particle size of 5.5 μm) | | |
| Anatase type titanium oxide (TiO₂) having an average | 0.1 | g |
| particle size of 0.4 μm: white pigment | | |
| Zinc oxide (ZnO) having an average particle size of | 0.1 | g |
| 0.6 μm: white pigment | | |
| Aqueous 10% by weight polyvinyl alcohol PVA117 | 0.01 | g |
| solution, produced by Kuraray Co., Ltd. | | |
| Acryl emulsion AE986A (solid content of 35% by | 0.6 | g |
| weight, produced by JSR Co., Ltd.) | | |

An image formation layer was coated in the same manner as printing plate material sample 101 in Example 1. Subsequently, an overcoat layer coating solution having the following composition was coated on the resulting image formation layer of the material with a wire bar to give a dry thickness of 0.4 g/m², and dried at 50° C. for 3 minutes, and the printing plate material was prepared. The resulting material was further subjected to seasoning treatment at 50° C. for 24 hours, and to humidity conditioning at 23° C. and 20% RH for 24 hours.

<<Overcoat Layer Coating Solution>>

| | | |
|---|---|---|
| Polyvinyl acetate | 15 | parts by weight |
| having a degree of saponification of 98% | | |
| (weight average molecular weight: 200,000) | | |
| Hexamethylene diisocyanate | 1 | part by weight |
| Matting agent (amorphous silica, | 2 | parts by weight |
| Average particle size: 2 μm) | | |
| Water | 82 | parts by weight |

The resulting printing plate material was treated in the same manner as in Example 1. The printing plate material was cut into a size of 73 cm (width)×32 m (length), and wound around a spool made of cardboard having a diameter of 7.5 cm. Thus, a printing plate sample in roll form was prepared. The resulting printing plate sample was wrapped in a 150 cm×2 m package made of Al₂O₃PET (12 μm)/Ny (15 μm)/CPP (70 μm) The wrapped material was stored at 60° C. and 60% RH for seven days. The package had an oxygen permeation of 1.7×10⁻⁵ ml/Pa·m²·30° C.·day, and a moisture permeability of 1.8×10−5 g/Pa·m²·25° C.·day.

The resulting printing plate sample was exposed for image formation in the same manner as in Example 1 to obtain the printing plate material (sample 201). Printing was carried out in the same manner as in Example 1, and the same evaluation as in Example 1 was carried out.

The results are shown in Table 6.

TABLE 6

| | | | | | Ink | |
|---|---|---|---|---|---|---|
| | | | Dot | Initial | stain | |
| | Sup- | Coating | image | ink | elimina- | |
| Sam- | port | imperfec- | quality | recep- | tion | |
| ple | used | tion | (Rank- | tivity | property | |
| No. | (No.) | (Ranking) | ing) | (number) | (number) | |
| 201 | 1 | 5 | 5 | 5 | 30 | Present |
| | | | | | | invention |

It is to be understood via Table 6 that the printing plate material in the present invention exhibits excellent properties of the coating imperfection, the dot image quality, the initial ink receptivity, and the ink stain elimination in non-image portions.

### EFFECT OF THE INVENTION

Structures 1-16 in the invention provide a printing plate employing its printing material comprising a polyester support with no coating imperfection, excellent dot image quality, rich ink receptivity at the beginning of printing and excellent ink stain elimination property in non-image portions, and the printing process thereof.

1. A printing plate material comprising a polyester support and provided thereon, an image formation layer, at least one adhesion layer being provided between the support and the image formation layer,
wherein the adhesion layer contains (A) a copolyester, (B) a water-soluble polymer selected from the group consisting of polyvinyl alcohol and polyvinyl pyrrolidone, and (C) particles.

2. The printing plate material of claim 1,
wherein the copolyester comprises in the molecule a hydroxyl group-containing component and a carboxylic acid component including a dicarboxylic acid component with a sulfonate group, and
wherein the content of the dicarboxylic acid component in the copolyester is from 1 to 16 mol % based on the carboxylic acid component.

3. The printing plate material of claim 1,
wherein a saponification degree of polyvinyl alcohol is from 75 to 95 mol %, or a K value of polyvinyl pyrrolidone is from 26 to 100.

4. The printing plate material of claim 1,
wherein the particles are organic or inorganic, and have an average particle size of from 20 to 80 nm.

5. The printing plate material of claim 1,
wherein the copolyester content is from 30 to 80% by weight, the water-soluble polymer content is from 5 to 50% by weight, and the particle content is from 1 to 30% by weight, based on the weight of the adhesion layer.

6. The printing plate material of claim 1,
wherein a thickness of the polyester support is from 100 to 300 μm.

7. The printing plate material of claim 1,
wherein the image formation layer contains heat melting particles and heat fusible particles.

8. The printing plate material of claim 1,
wherein at least one hydrophilic layer is provided between the adhesion layer and the image formation layer.

9. The printing plate material of claim 8,
wherein the at least one hydrophilic layer has a porous structure.

10. The printing plate material of claim 1,
wherein the printing plate material comprises a layer containing a light-heat conversion material.

11. The printing plate material of claim 10,
wherein the image formation layer or the hydrophilic layer contains the light-heat conversion material.

12. The printing plate material of claim 1,
wherein a hydrophilic overcoat layer is provided on the image formation layer.

13. The printing plate material of claim 12,
wherein the hydrophilic overcoat layer contains the light-heat conversion material.

14. The printing plate material of claim 1,
wherein the printing plate material is wound around a core having a size of 4 to 10 cm so as to form a printing plate material roll.

15. A printing plate which is obtained by unwinding the printing plate material from the printing plate material roll of claim 14,
and imagewise exposing the image formation layer of the unwound printing plate material, employing later beams.

16. A printing process comprising the steps of producing through-holes in the printing plate of claim 15, and fixing the resulting printing plate on a plate cylinder of a printing press, employing the through-holes.
